(19) United States
(12) Patent Application Publication
(10) Pub. No.: US 2007/0108319 A1
(43) Pub. Date: May 17, 2007

(54) Burner and gas-injection device

(76) Inventors: Enzo Ruscio, Gemona Del Friuli (IT); Claudio Contardo, Muris Di Ragogna (IT); Carlo Travaglini, Udine (IT)

Correspondence Address: Kit M Stetina;Stetina Brunda Garred & Brucker, 75 Enterprise, Suite 250, Aliso Viejo, CA, 92656, US

(21) Appl. No.: 10/563,690

(22) PCT Filed: Jul. 9, 2004
(86) PCT No.: PCT/EP04/51437

§ 371 Date: Jan. 5, 2006

(30) Foreign Application Priority Data
Jul. 9, 2003 (IT) MI2003A001397

(51) Int. Cl. B05B 1/14; B05B 1/26; A62C 2/08

(52) U.S. Cl. 239/548; 239/601; 239/556; 239/558

(57) ABSTRACT

A burner and oxygen-injection device (35) for a melting furnace (30) comprising one or more injectors (3, 3′, 3″) consisting of an internal pipe (1) and a head (2), which is fixed to one end of said hollow body and is provided with a nozzle (4) that sets the pipe (1) in communication with the outside. The nozzle has at least the outlet cross section (13) of a substantially oblong shape, in such a way that a subsonic flow of oxygen coming out of said nozzle will open in fanwise fashion, along an inclined plane containing an axis that is substantially horizontal and orthogonal to the axis of the nozzle. The injector (3) comprises holes (6) for injection of gaseous fuel, around said nozzle, arranged along the elongated sides of the outlet cross section of the nozzle. The device (35) also comprises a pipe for injection of carbon in powder form set underneath the nozzle or nozzles (3, 3′, 3″).

### FIELD OF THE INVENTION

The present invention relates to a burner and gas-injection device, suited to uses in the metallurgy sector, in the operations of melting metal material, for example ferrous material, such as scrap iron. The device may advantageously, but not exclusively, find use in electric-arc furnaces (EAFs). The device may advantageously be suited to functioning as injector and/or as burner according to the conditions of supply, which may vary in the various steps of the melting process.

### STATE OF THE ART

Devices for injection of oxygen and other materials, such as fuels, whether gaseous, solid (such as powdered carbon), or liquid, today find extensive use in the steel industry, and in particular are used in melting processes for the production of steel or other metals, in particular in electric-arc furnaces (EAFs) for heating and melting of the metal burden, for increasing the energy supplied to the process by the primary energy source (electrical energy in the case of EAFs). The injection of the various components has also the function of promoting the necessary chemical reactions within the furnace, both in the molten metal and in the layer of dross that floats on top of the molten metal, as well as in the atmosphere within the furnace, such as for example reactions of carburizing and decarburizing. Different devices have been proposed for injection of the various components into a furnace. There exist modules that comprise injectors for oxygen and for gaseous fuels, such as, for example, methane, and injectors for solid fuels, such as powdered carbon. However, the modules according to the known art do not always enable an optimal distribution of the various components supplied. For example, there is felt the need for a better combustion, preferably within the layer of dross, of the carbon monoxide produced by the reaction between carbon and oxygen. Said better combustion, with consequent better recovery of the calorific value of the CO, must be able to be performed without there occurring any excessive decarburizing within the bath of molten metal or of the layer of dross.

### SUMMARY OF THE INVENTION

For the purpose of solving the problems set forth above, there has now been developed a new type of burner and gas-injection device, in particular for application in the field of metallurgy, more particularly for application to melting furnaces such as electric-arc furnaces.

The device according to the present invention comprises an injector, which includes a hollow body, preferably cylindrical, having a longitudinal axis, a first Internal pipe and a head, fixed to one end of said hollow body, provided with at least one nozzle that sets said first pipe in communication with the outside, said nozzle having at least the outlet cross section of a substantially oblong shape, such that a fluid that is made to flow from said first pipe outwards may open out in fanwise fashion parallel to a plane; preferably said plane is a plane of symmetry of the nozzle. Preferably, said nozzle has a convergent-divergent pattern in the passage from said first pipe to the outside; according to a possible aspect of the invention, just the divergent portion has an oblong cross section, whilst the remaining portions have a non-oblong cross section, i.e., square or, preferably, round. The divergent cross section has thus increasingly elongated cross sections in the passage from the restricted cross section of the nozzle to the outside. According to a preferred aspect, the cross section of the nozzle, in the divergent stretch, may present two perpendicular axes of symmetry, the maximum width according to one of said axes, referred to as “minor axis”, remaining substantially unvaried in the passage from said restricted cross section to the outside, the maximum width according to the other axis, increasing progressively from said restricted cross section to the outside. The cross sections in the divergent stretch may, for example, be rectangular, elliptical, or preferably, have the shape of a rectangle with the ends rounded off.

Preferably said nozzle has an axis of symmetry, which coincides with the longitudinal axis of said hollow body, and said first pipe is cylindrical and coaxial with said hollow body.

There is preferably present a second pipe, which may be set around said first pipe, preferably coaxial therewith. One or more holes set in communication said second pipe with the outside. Preferably, said holes are arranged along a circumference that is concentric with respect to the longitudinal axis. If the outlet cross section of the nozzle has a minor axis as described above, said holes will be arranged within an angle α, centred on said longitudinal axis with respect to said minor axis, that is not greater than 45°; for example, there may be holes on said minor axis and symmetrical holes at an angle of approximately 30°.

The injector preferably comprises a cooling jacket for circulation of a cooling fluid, for example water.

The invention also relates to a method for supplying components to a furnace for melting metal material by means of a device comprising the supply of oxygen through the nozzle, in which the oxygen is preferably injected in the layer of dross, and comprising the supply of carbon through a pipe for injection of carbon, in which the carbon is injected underneath the pipe for injection of oxygen and, preferably, within the layer of dross.

If the outlet cross section has a major axis as described above, said major axis must be set in a substantially horizontal direction. The method may comprise the supply of a fuel gas, such as methane, to said second pipe.

The method may comprise the supply of oxygen from a series of injectors and of powdered carbon by means of purposely provided pipes set underneath said injectors. According to a preferred aspect of the invention, the injection device comprises at least three gas injectors per carbon-injection pipe.

### BRIEF DESCRIPTION OF THE FIGURES

Further characteristics and advantages of the invention will emerge more clearly in the light of the detailed description of a preferred but non-exclusive embodiment of a burner for electric-arc furnaces, illustrated by way of non-limiting example, with the aid of the attached plates of drawings, in which:

FIG. 1 is a schematic illustration of a longitudinal cross section of an injector comprised in the burner and gas-injection device according to the invention;

FIG. 2 is a schematic illustration of a front view from the side of the head of the injector of FIG. 1;

FIGS. 3 and 4 illustrate two views in longitudinal cross section of a head of the injector of FIG. 1 according to the planes designated by the letters B and A, respectively, in FIG. 2;

FIG. 5 illustrates a cross section of a detail of a melting furnace comprising a burner and gas-injection device according to the invention; and

FIG. 6 illustrates an axonometric view of a burner and gas-injection device according to the invention.

### DETAILED DESCRIPTION OF PREFERRED EMBODIMENTS

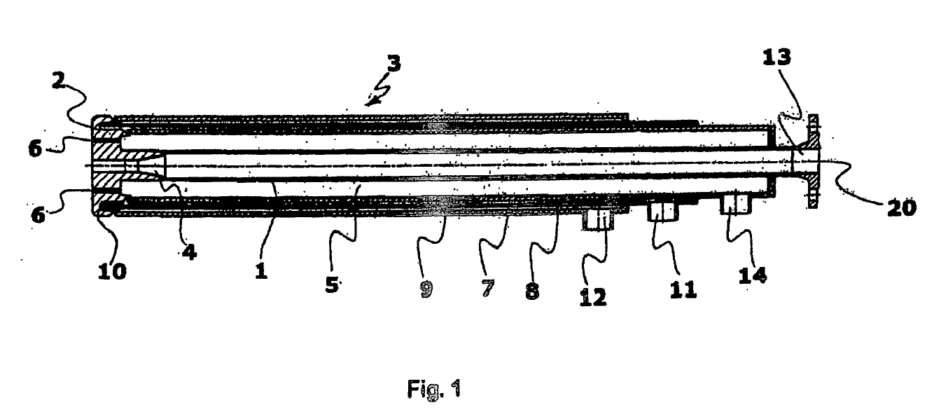

With particular reference to FIG. 1, the longitudinal cross-sectional view represents an injector 3 according to the present invention, comprising a head 2, made of appropriate material, generally copper, and a cylindrical body. There is present a first pipe 1 set in communication with the outside by the nozzle 4 of the head, and a second pipe 5 set in communication with the outside by the holes 6. There is also present a cooling jacket for circulation of cooling water. It is divided into the two parts 7 and 8 separated by the tube 9, which, unlike the various other tubes that delimit the various pipes does not form a seal against the head 2. Located between the head and the tube 9 is a port 10.

In this way, the cooling water may be fed in, for example, through the inlet 11 and then flow off through the outlet 12, or vice versa, after circulating throughout the cooling jacket, thus obtaining an effective heat exchange thanks to the high speed of the water. The reference numbers 13 and 14 designate, respectively, the inlets for the gas to be fed to the first pipe 1, preferably oxygen, and to the second pipe 5, preferably a fuel, such as methane.

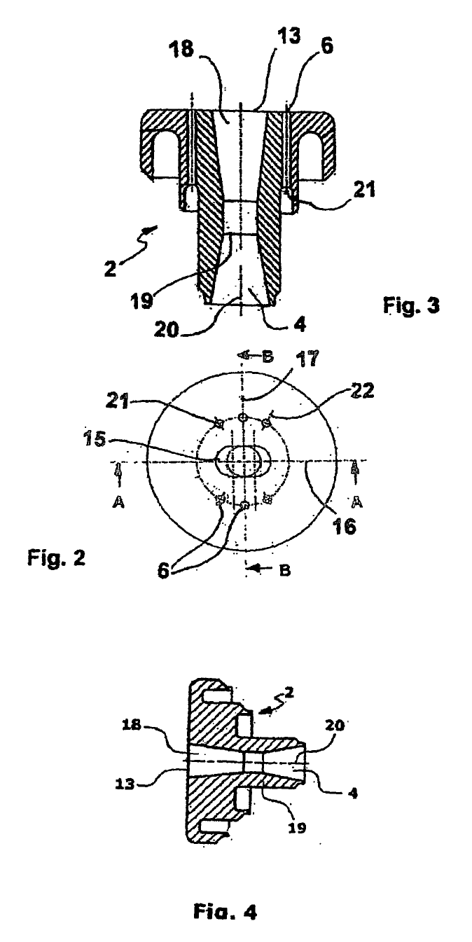

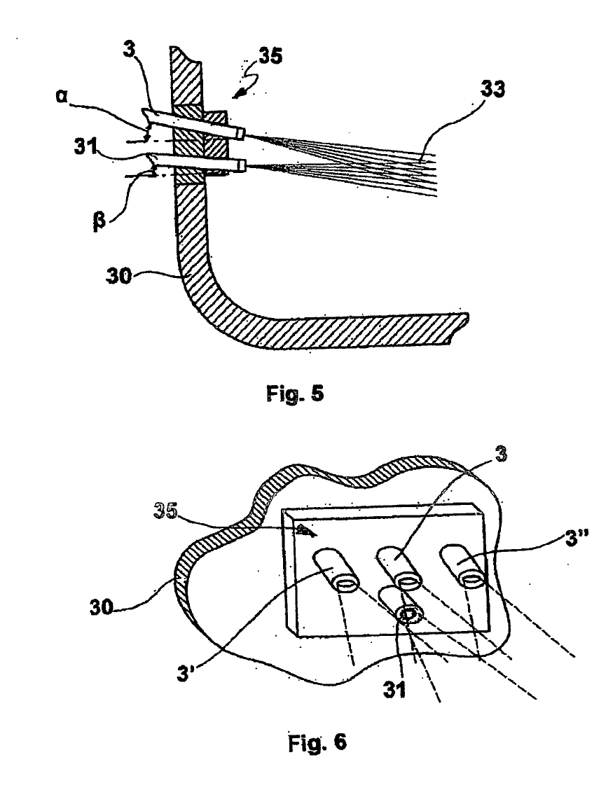

As has been said, the nozzle 4 has an oblong cross section at the outlet 15, as may be noted from FIGS. 2, 3 and 4, such as to cause widening out, in fanwise fashion, of a flow of gas that will flow through it. In particular the final divergent stretch 18 will have oblong cross sections, increasingly elongated in the passage between an initial cross section 19, which is not oblong, and the outlet cross section 13. Said initial cross section 19 may coincide with the start of the divergent stretch. In general, the cross sections of the final divergent stretch may have two axes of symmetry perpendicular to one another, one of which is referred to as “major axis” 16, along which the width of the cross sections is maximum, and the other of which is referred to as “minor axis” 17, along which the width is minimum.

Preferably, the width of the cross section increases towards the outlet just in the direction of the major axis, in such a way that the flow widens out in fanwise fashion only in a plane containing the major axis and the longitudinal axis 20 of the nozzle, which, as has been seen, coincides preferably with the longitudinal axis of the hollow body.

The holes 6 that enable output of the gas fed to the second pipe are preferably arranged on a circumference concentric with the axis 20 of the nozzle, and are preferably arranged in a manner symmetrical with respect to the major axis if present, and more preferably are symmetrical also with respect to the axis 20 of the nozzle. They are preferably arranged only in the proximity of the minor axis. The straight line 22 lying on the plane transverse to the longitudinal axis 20, i.e., the plane of the major and minor axes, which joins the axis 21 of one of said holes, will form an angle comprised between 0° and 45° with the minor axis. Preferably, the axes of the holes 6 will be parallel to the axis 20 of the nozzle. According to a particular aspect, there may be six holes, two arranged on the minor axis and four arranged at an angle, as defined above, of approximately 30° with respect to said axis.

According to a preferred method of operation, in order to inject process gas into a furnace 30 for melting metal material, preferably an electric-arc furnace, oxygen is fed into the central pipe, so as to have subsonic outflow from the nozzle. Preferably, a number of injectors 3, 3′, 3″ are arranged along the walls of the furnace 30, more preferably at a level within the layer of dross. The injectors 3, 3′, 3″ are arranged in such a way that the outlet cross section of the nozzles will have the maximum width in a substantially horizontal direction; if the major axis is present it is set preferably horizontally. The axis of the nozzle may be inclined downwards towards the inside of the furnace 30, set so as to form an angle α with a horizontal plane between 25° and 55°, preferably between 38° and 43°. A fuel gas, such as methane, may be fed to the second pipe in such a way that it will flow away through the holes 6. In this way, the injector functions as an injector burner. In the decarburizing stages, in order to increase penetration of the oxygen in the metal bath, the supply may be such that the outflow through the nozzle is supersonic. The injector in these cases may be fed only with oxygen, or else sometimes it is preferred to use flows of gas from the side nozzles, which, by determining a corona effect, enable the rate of penetration of the jet to be increased.

Advantageously, there may be envisaged injection into the furnace of powdered carbon, through purposely provided pipes 31. The openings of the pipes are positioned preferably along the walls of the furnace 30 within the layer of dross, but underneath the oxygen injectors 3. Said pipes for injection of the carbon have an axis in a position corresponding to the outlet that will preferably be set inclined downwards towards the inside of the furnace, with an angle β with respect to the horizontal plane comprised between 20° and 40°. Preferably, the axis of a carbon-injection pipe 31 will cross the axis of at least one oxygen injector 3 in an area 33 within the layer of dross. Preferably, there are provided at least three injectors 3, 3′, 3″ of gas through the carbon-injection pipe 31. A carbon-injection pipe may be advantageously arranged along the vertical underneath a gas injector at a distance comprised between 200 mm and 400 mm. The gas injectors are preferably arranged at the same level, at a distance of at least 350 mm from one another.

There may be provided, and these form a subject of the invention, burner and gas-injection devices, also normally referred to, for reasons of brevity, as modules, comprising at least three injectors 3, 3′, 3″, as discussed above, and a pipe 31 for feeding carbon in powder form, as illustrated in FIG. 6. The injectors are arranged in line, and the carbon-injection pipe is set underneath the central injector. The two side injectors 3′, 3″ are set at a distance from the central injector preferably comprised between 350 mm and 500 mm.

The head 2 of an injector 3, made of copper and cooled by water, is located on a panel of copper-steel bimetallic sheet, cooled by water under forced circulation.

The cooling jacket obtained between a metal counter-plate and a bimetallic sheet forces the water at a high speed and with an equal loss of head, with the result of obtaining a high efficiency of dissipation of the heat. Operation proceeds preferably in a turbulent regime, for the purpose of maximizing the coefficient of heat exchange.

The conformation of the oxygen injectors, as well as their arrangement, has the purpose of creating an area enriched with oxygen overlying the area of formation of CO.

Said enriched area intercepts the CO and transforms it into CO₂, with development of energy, which is accumulated in the dross, which in turn performs the function of heat flywheel within the molten scrap.

Conditions of low density of the charged scrap (400-600 kg/m³) are to be considered preferable for this practice of energy contribution of chemical origin.

Experiments have demonstrated that the combustion, even partial, of the CO that is formed during the process of melting, has the effect of reducing the specific consumption of carbon normally used in the process (in terms of kilograms of carbon per tonne of produced steel) precisely on account of the subsonic nature of the jet of oxygen, which does not decarburize (i.e., decreases the content of carbon in the bath of molten steel), but intercepts the CO in the dross, converting it into CO₂.

The dimensions of an injector 3 may be adjusted on the basis of the process requirements, according to the experience of the person skilled in the branch. For an injector of nominal flow-rate of between 4000 Nm³/h and 5000 Nm³/h of oxygen, purely by way of rough indication, the total length may be between 1 m and 1.5 m, the external diameter may be between 100 mm and 200 mm, the diameter of the nozzle in the restricted cross section may be between 15 mm and 20 mm, and the major width at the outlet may be between 25 mm and 40 mm.

1. A burner and gas-injection device for melting furnaces for metal material comprising at least one injector (3) for gas having a hollow body defining a longitudinal axis (20), a first internal pipe (1) and a head (2), fixed to one end of said hollow body, provided with at least one nozzle (4) that sets said first pipe in communication with the outside, the nozzle (4) having at least an outlet cross section (13) outwards of a substantially oblong shape, the device comprising at least one pipe for injection of carbon (31) in powder form set underneath the nozzle (4).

2. The device according to claim 1, in which the nozzle (4) has a divergent end stretch (18), in which the cross sections have a progressively more elongated shape in the direction of the outlet cross section.

3. The device according to any of the preceding claims in which the nozzle (4) has a convergent-divergent shape.

4. The device according to any of the preceding claims in which the nozzle (4) is coaxial with the cylindrical body.

5. The device according to any of the preceding claims, in which the cross section of the nozzle (4), in the divergent stretch has two perpendicular axes of symmetry, the maximum width according to one of said axes, referred to as minor axis (17), remaining substantially unvaried in the passage from said restricted cross section on the outside, the maximum width according to the other axis, referred to as major axis (16) increasing progressively towards the outlet cross section.

6. The device according to any one of the preceding claims, in which the outlet cross section of the nozzle (4) is elliptical, rectangular, or rectangular with the edges rounded off.

7. The device according to any one of the preceding claims, comprising a second pipe (5), set coaxially around said first pipe, and one or more second holes (6), made in the head, said second holes putting in communication said second pipe (5) with the outside.

8. The device according to claim 7, in which the second holes (6) are arranged around said nozzle (4), along a circumference concentric with the axis of the nozzle (4).

9. The device according to claim 5 and any claim from claim 7 to claim 8, in which said holes (6) are arranged within an angle (a), centred on said longitudinal axis and co-planar with a cross section of the nozzle (4), with respect to said minor axis, not greater than 45°, preferably not greater than 30°.

10. The device according to claim 9, in which the second holes (6) are symmetrical with respect to said major and minor axes and define respective axes parallel to the axis of the nozzle (4).

11. The device according to one or more of the preceding claims, in which there are provided three injectors (3,3′, 3″) arranged with respective axes substantially parallel and co-planar.

12. A method for supplying components to a furnace for melting metal material by means of a device according to any of the preceding claims, comprising the supply of oxygen through the nozzle (4), in which the oxygen is injected in the layer of dross, and comprising the supply of carbon through a pipe for injection of carbon, in which the carbon is injected in the layer of dross and underneath the pipe for injection of oxygen.

13. The method according to claim 12, in which the outflow of the oxygen through the nozzle (4) is subsonic.

14. The method according to claim 13, in which the nozzle (4) for the oxygen is set in such a way that the outlet cross section presents the maximum width in a substantially horizontal direction.

15. The method according to any one of claims 12 to 14, in which a fuel gas is fed through the second pipes.
